(19) United States
(12) Patent Application Publication
(10) Pub. No.: US 2012/0139486 A1
(43) Pub. Date: Jun. 7, 2012

(54) SYSTEM FOR EXTENDING THE DRIVING RANGE OF AN ELECTRIC VEHICLE

(75) Inventor: Dewey T. Holland, Martinez, GA (US)

(73) Assignee: HYDRIVE VEHICLES, INCORPORATED, Martinez, GA (US)

(21) Appl. No.: 12/958,626

(22) Filed: Dec. 2, 2010

(51) Int. Cl. H02J 7/00

(52) U.S. Cl. 320/109

(57) ABSTRACT

A system for extending the driving range of an electric vehicle is disclosed. The system may generally include a generator mounted on or within the electric vehicle and configured to generate a DC power output for recharging the batteries of the electric vehicle. The generator may include a controller configured to implement a charging algorithm for controlling the DC power output supplied to the batteries. The charging algorithm may be designed to maintain the batteries below a predetermined state-of-charge corresponding to a transition point in a charging cycle of the batteries between a bulk charging phase and an absorption charging phase. Additionally, the system may include a generator cable configured to electrically connect the generator directly to the batteries.

### CROSS-REFERENCE TO RELATED APPLICATIONS

This application is related to the concurrently filed U.S. Patent Application entitled “SYSTEM FOR EXTRACTING ELECTRICAL POWER FROM AN ELECTRIC VEHICLE,” assigned U.S. Ser. No. ______ and filed Dec. 2, 2010, which is hereby fully incorporated herein by reference for all purposes.

### FIELD OF THE INVENTION

The present subject matter relates generally to electric vehicles and, more particularly, to a system for extending the driving range of an electric powered golf car, hunting vehicle or low-speed-vehicle.

### BACKGROUND OF THE INVENTION

Small electric powered vehicles, such as golf cars, hunting vehicles and low-speed-vehicles (LSVs), generally offer an economical and environmentally friendly method of transportation around golf courses, neighborhoods and other low-traffic areas. Moreover, the popularity of such vehicles has significantly increased in recent years due to the increased costs of gasoline and an increase in closed and retirement communities. As is generally known, the usable driving range of an electric vehicle is limited by the energy storage capacity of its batteries. Thus, when a driver of an electric vehicle neglects to charge the vehicle's batteries, the batteries may become depleted of power, often leaving the driver stranded in a remote location.

Known applications for extending the driving range of an electric vehicle include utilizing an alternating current (AC) output generator coupled indirectly to the batteries through the vehicle's existing AC battery charger. While this configuration has been used to extend the range of an electric vehicle, it has numerous disadvantages. For example, both the generator and the charger must be mounted on the electric vehicle, which substantially increases the weight and cost of the vehicle and also increases wiring/installation complexity. Additionally, the power input to the batteries is significantly limited by the electrical capacity of the battery charger. In particular, a typical battery charger is generally limited in size to the amount of power available from a conventional wall outlet (e.g., about 750 watts). As such, the power output of the generator to move a golf car or LSV (e.g., 2000 watts are more) is not efficiently utilized. Moreover, typical battery chargers do not respond to the changes in battery voltage caused by various driving conditions, such as going uphill or a power surge from the drive motor supplying power back to the batteries while braking This deficiency usually results in the battery charger defaulting to its base power settings of approximately 400 watts to prevent battery damage, which is substantially insufficient to support the power requirements of an electric vehicle while in operation. Further, the output from the generator and the output from the charger must generally be calibrated to avoid scenarios in which the generator cycles its power output up and down in an attempt to match the charger's input requirements.

Accordingly, there is a need for a system that provides for a simple, efficient and cost effective means for extending the driving range of an electric golf car, hunting vehicle or LSV.

### BRIEF DESCRIPTION OF THE INVENTION

Aspects and advantages of the present subject matter will be set forth in part in the following description, or may be obvious from the description, or may be learned through practice of the present subject matter.

In one aspect, the present subject matter discloses a system for extending the driving range of an electric vehicle. The system may generally include a generator mounted on or within the electric vehicle and configured to generate direct current (DC) power output for recharging the batteries of the electric vehicle. The generator may include a controller configured to implement a charging algorithm for controlling the DC power output supplied to the batteries. The charging algorithm may be designed to maintain the batteries below a predetermined state-of-charge corresponding to a transition point in a charging cycle of the batteries between a bulk charging phase and an absorption charging phase. Additionally, the system may include a generator cable configured to electrically connect the generator directly to the batteries.

In another aspect, the present subject matter discloses a system for extending the driving range of an electric vehicle. The system may generally include a generator configured to generate a DC power output for recharging the batteries of the electric vehicle. The generator may include a controller configured to implement a charging algorithm so as to maintain a state-of-charge of the batteries below a predetermined state-of-charge ranging from about 75% to about 85%. The predetermined state-of-charge generally corresponds to a transition point in a charging cycle of the batteries between a bulk charging phase and an absorption charging phase. The generator may further include a starter motor configured to require an input voltage corresponding to an output voltage of the batteries. Additionally, the system may include a generator cable configured to electrically connect the generator directly to the batteries. The generator cable may generally include a first cable segment coupled between the batteries and a secondary charging receptacle of the electric vehicle and a second cable segment coupled between the secondary charging receptacle and the generator.

In a further aspect, the present subject matter discloses a portable system for extending the driving range of an electric vehicle. The system may generally include a portable generator configured to generate a DC power output for recharging the batteries of the electric vehicle. The generator may include a controller configured to implement a charging algorithm for controlling the DC power output supplied to the batteries. The charging algorithm may be designed to maintain the batteries below a predetermined state-of-charge corresponding to a transition point in a charging cycle of the batteries between a bulk charging phase and an absorption charging phase. Additionally, the system may include a generator cable configured to electrically connect the generator directly to the batteries. The generator cable may generally include a charger plug configured to be received within a charging receptacle of the electric vehicle.

By limiting DC power input at a level below the vehicle's battery absorption phase and supplying power only during the bulk charging phase, numerous advantages are provided to the disclosed system. Specifically, by avoiding charging during the absorption phase, substantially greater power can be supplied more efficiently to the batteries. In addition, the batteries are protected from overcharging and excess gassing of electrolyte.

These and other features, aspects and advantages of the present subject matter will become better understood with reference to the following description and appended claims. The accompanying drawings, which are incorporated in and constitute a part of this specification, illustrate embodiments of the present subject matter and, together with the description, serve to explain the principles of the present subject matter.

### BRIEF DESCRIPTION OF THE DRAWING

A full and enabling disclosure of the present subject matter, including the best mode thereof, directed to one of ordinary skill in the art, is set forth in the specification, which makes reference to the appended figures, in which:

FIG. 1 illustrates a perspective view of a suitable electric vehicle for use with the disclosed system;

FIG. 2 illustrates a partial, top view of one embodiment of a system for extending the driving range of an electric vehicle in accordance with aspects of the present subject matter;

FIG. 3 illustrates a chart of the typical three-phase charging cycle of a battery;

FIG. 4 illustrates a partial, top view of another embodiment of a system for extending the driving range of an electric vehicle in accordance with aspects of the present subject matter;

FIG. 5 illustrates a partial, perspective view of embodiments of many of the components and features of the system illustrated in FIG. 4;

FIG. 6 illustrates a perspective view of one embodiment of an adapter member configured to be utilized with the disclosed system in accordance with aspects of the present subject matter; and

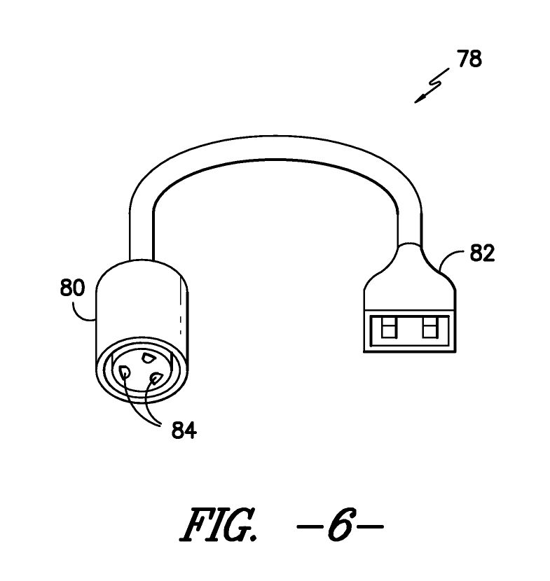

FIG. 7 illustrates a perspective view of one embodiment of a portable system for extending the driving range of an electric vehicle in accordance with aspects of the present subject matter.

### DETAILED DESCRIPTION OF THE INVENTION

Reference now will be made in detail to embodiments of the present subject matter, one or more examples of which are illustrated in the drawings. Each example is provided by way of explanation of the present subject matter, not by way of limitation. In fact, it will be apparent to those skilled in the art that various modifications and variations can be made in the present subject matter without departing from the scope or spirit of the present subject matter. For instance, features illustrated or described as part of one embodiment can be used with another embodiment to yield a still further embodiment. Thus, it is intended that the present subject matter covers such modifications and variations as come within the scope of the appended claims and their equivalents.

Referring now to the drawings, a system 10 for extending the driving range of an electric vehicle will generally be described in accordance with aspects of the present subject matter. In particular, the disclosed system 10 will be described with reference to a golf car 12. However, the golf car 12 illustrated and described herein is generally provided for illustrative purposes only to place the present system 10 in an exemplary field of use. Thus, one of ordinary skill in the art should appreciate that the present system 10 is not limited to any particular type of golf car configuration. Similarly, it should be appreciated that the present system 10 need not be limited to use with golf cars 12, but may generally be utilized with any electric vehicle. In particular, as used herein, the term “electric vehicle” may refer to golf cars, electric powered hunting vehicles (e.g., all-terrain vehicles (ATVs)) and low-speed vehicles (LSVs). The term “low-speed vehicle” or “LSV” refers to vehicles qualifying as such under Federal Motor Vehicle Safety Standard (FMVSS) 208 promulgated by the U.S. Department of Transportation, National High Traffic Safety Administration, essentially a modified electric golf car for street legal use.

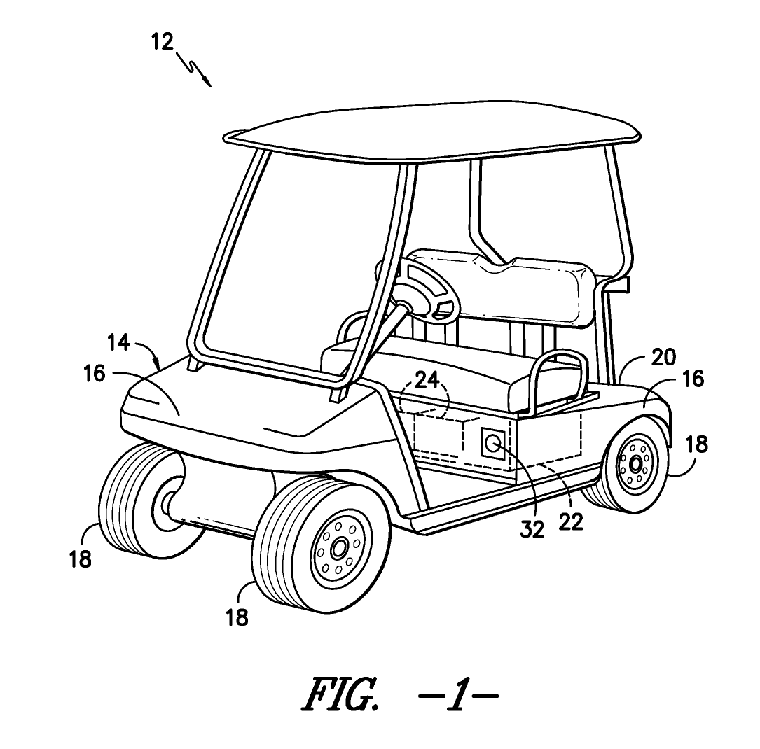

Referring to FIGS. 1, 2 and 3, the illustrated golf car 12 generally comprises a body 14 having an outer shell 16 defining the exterior surface and shape of the golf car 12 and a chassis (not illustrated) configured to provide structural support for the various components of the golf car 12. The golf car 12 may also include a plurality of wheels 18 configured to be driven by an electric motor or motors (not illustrated) disposed within the body 14. Additionally, a bag well 20 may generally be formed in a rearward portion of the golf car 12 for storing golf bags and other suitable items.

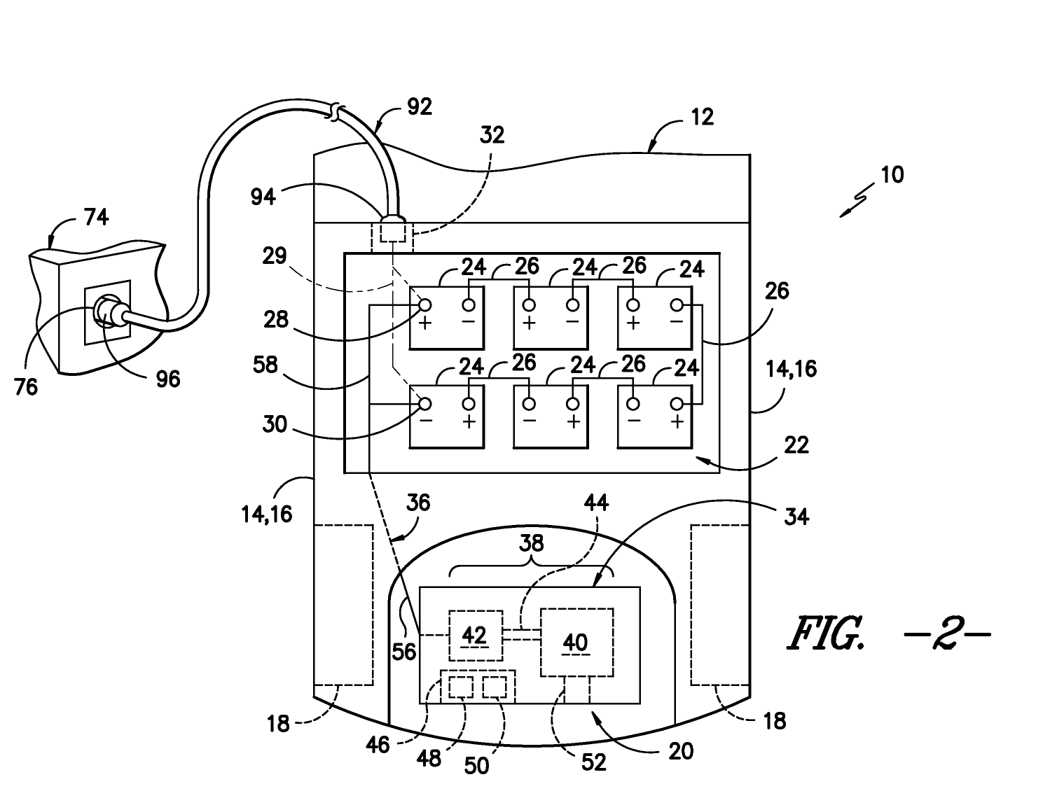

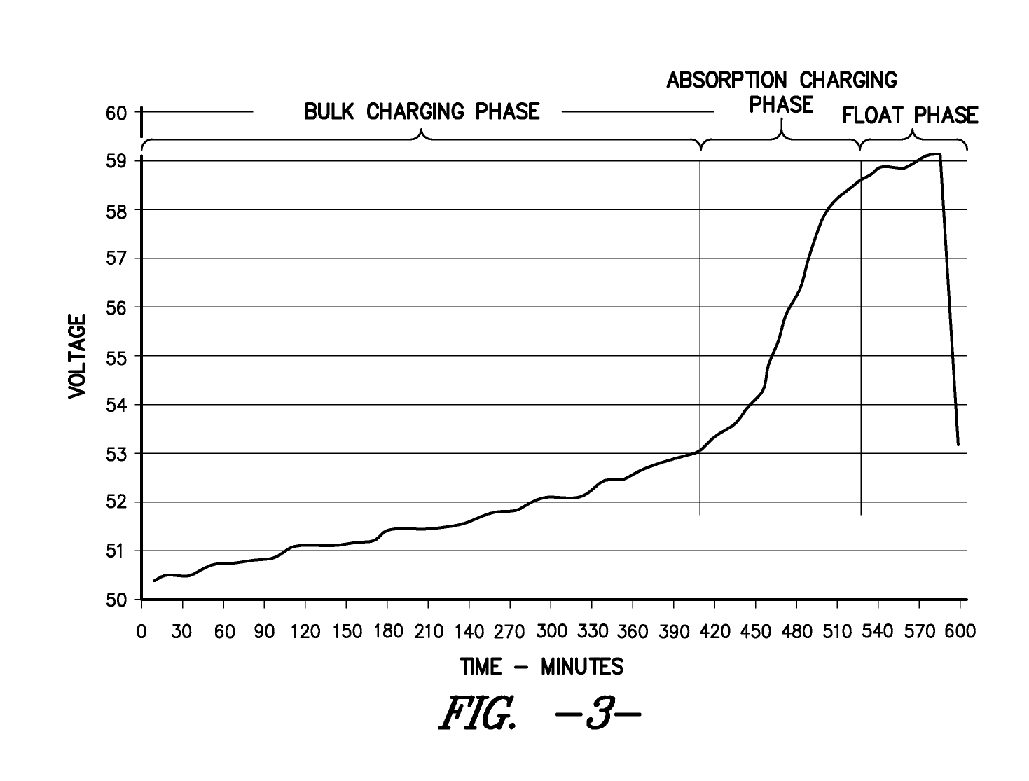

As shown, the golf car 12 may also include a battery well 22 housing a plurality of batteries 24 configured to supply power to the electric motor (not illustrated). In general, the golf car 12 may include any number of batteries 24. For example, as shown in FIGS. 2 and 3, in one embodiment, the golf car 12 may include six batteries 24 connected in series by a plurality of cross-over cables 26. Specifically, the cross-over cables 26 may be configured to electrically connect the batteries 24 in series by coupling corresponding positive and negative posts 28, 30 of adjacent batteries 24 to one another. In alternative embodiments, it should be appreciated that the golf car 12 may include less than six batteries 24 or greater than six batteries 24. Additionally, it should be appreciated that the batteries 24 may be configured to output any suitable voltage. For example, in the embodiments shown in FIGS. 2 and 3, each battery 24 may be rated to output six to eight volts so as to supply a thirty-six or forty-eight volt output to the electric motor of the golf car 12.

Further, the golf car 12 may include a charging system configured to permit the batteries 24 to be recharged after use. For example, the golf car's charging system may include a primary charging receptacle 32 electrically coupled to the batteries 24. As is generally understood, the charging receptacle 32 may be configured such that a charging cable (not illustrated) of a peripheral charging unit (not illustrated) may be plugged into the receptacle 32. Additionally, a cable 29 (shown in phantom lines) may generally extend between the charging receptacle 32 and the positive and negative posts 28, 30 of the batteries 24 to permit DC power supplied by the peripheral charging unit to be transmitted from the charging receptacle 32 to the batteries 24. Of course, it should be appreciated that the golf car 12 may generally include any suitable type of charging system and, thus, need not include the exact configuration and/or components illustrated and described herein.

Referring particularly now to FIG. 2, one embodiment of a system 10 for extending the range of a golf car 12 is illustrated in accordance with aspects of the present subject matter, particularly illustrating a top view of a rearward portion of the golf car 12 (i.e., the portion including the bag well 20 and the battery well 22). As shown, the system 10 generally includes a generator 34 coupled to the batteries 24 through a generator cable 36. The generator 34 may generally be configured to produce electrical power that can be transmitted through the generator cable 36 to recharge the batteries 24 of the golf car 12. As such, the disclosed system 10 may provide for the extension of the driving range of the golf car 12, as any power used by the batteries 24 during operation may be replenished while the golf car 12 is still being used or while it is stationary.

In the illustrated embodiment, the generator 34 is mounted or otherwise disposed within the bag well 20 of the golf car 12. However, it should be appreciated that the generator 34 may generally be mounted or otherwise disposed at any suitable location on or within the golf car 12. For example, in several embodiments, the generator 34 may be mounted to a portion of the body 14 of the golf car 12 or may be disposed within the battery well 22. Alternatively, the generator 34 may be configured as a portable device which may be disposed completely separate from the golf car 12.

In general, the generator 34 of the present subject matter may be configured as a direct current (DC) generator for generating a DC power output for recharging the batteries 24. Thus, it should be appreciated that the generator 34 may include any suitable power generation assembly 38 known in the art. For example, in the illustrated embodiment, the power generation assembly 38 of the generator 34 may comprise an internal combustion engine 40 coupled to one or more alternators 42. As is generally understood, the internal combustion engine 40 may be configured to combust any suitable fuel (e.g., gasoline, diesel fuel, propane or the like) so as to produce a rotational output adapted to drive the alternator(s) 42. For instance, a shaft 44 of the engine 40 may be directly coupled to the alternator(s) 42 to permit the rotational output of the engine 40 to be transferred to the alternator 42. Alternatively, the rotational output of the internal combustion engine 40 may be transmitted to the alternator 42 using any other suitable means, such as by using a belt and pulley mechanism or any other suitable mechanism. Additionally, the alternator(s) 42 may be configured to convert the rotational energy produced by the engine 40 to electrical power which may then be utilized to charge the batteries 24 of the golf car 12. Of course, it should be appreciated that, in alternative embodiments, the generator 34 may include any other suitable power generation assembly 38 known in the art for generating electrical power.

Additionally, the generator 34 may also include a controller 46 configured to control the generator's power output so as to ensure that the batteries 24 are not overcharged and thereby damaged. As such, the controller 46 may generally comprise any suitable processing unit (e.g., a computer, microcontroller and the like), any suitable circuitry (e.g., an application specific circuit, module control board/circuit and the like) or any combination of processing units and/or circuitry which may be configured to monitor the state-of-charge (SOC) of the batteries 24 and/or regulate the power output of the generator 34. For example, in the illustrated embodiment, the controller 46 may comprise a central processing unit (CPU) including one or more processors 48 and associated memory devices 50 configured to perform any number of computer-implemented functions (e.g., software-based SOC monitoring and power output control). Thus, the processors 48 may generally be configured to implement any suitable computer-readable and executable software instructions stored on the memory devices 50. Additionally, the memory devices 50 may generally comprise single or multiple portions of one or more varieties of computer-readable media, such as but not limited to volatile memory (e.g., random access memory (RAM), such as DRAM, SRAM, etc.), nonvolatile memory (e.g., ROM, flash, hard drives, magnetic tapes, CD-ROM, DVD-ROM, etc.) and any combinations thereof. In an alternative embodiment, it should be appreciated that the controller 46 may include one or more application specific circuits configured to monitor the SOC of the batteries 24 and regulate the power output to the batteries 24 by implementing any suitable hard wired logic or other circuitry.

In accordance with several embodiments of the present subject matter, the controller 46 may include or be programmed with a charging algorithm designed to control the DC power output of the generator 34. Thus, in one embodiment, the charging algorithm may be stored as software instructions on the memory devices 50 which may then be executed by the processors 48. In general, the charging algorithm may be designed to prevent battery damage from occurring due to overcharging. Thus, the charging algorithm may be adapted to monitor the charging status of the batteries 24 so that the power output supplied to the batteries 24 by the generator 34 may be limited or stopped when the batteries 24 reach a predetermined SOC generally corresponding to the point in the batteries' charging cycle at which the likelihood of battery damage becomes substantial.

It should be understood by those of ordinary skill in the art that re-chargeable batteries, such as a golf car's batteries 24, typically undergo a three phase charging cycle. For example, a chart depicting the charging cycle of a typical re-chargeable battery is provided in FIG. 3. In the first phase, referred to herein as the bulk charging phase, a battery generally stores a significant amount of power with negligible risk of damage. For example, a battery may absorb from around 75% to about 85% of its storage capacity during the bulk charging phase. However, once a battery has reached a SOC of about 75% to about 85%, the charging cycle transitions from the bulk charging phase to an absorption charging phase. In this phase, the battery continue to absorb power (e.g., about 15% to about 25% of their storage capacity), but not all of the power input to the battery is converted to stored energy. Specifically, a portion of the inputted power during the absorption phase begins to break down the electrolytes within the battery, which produces heat and gases (e.g., hydrogen and oxygen). Accordingly, the risk of damage to the battery during this phase is substantially increased, as increased power input can result in excessive heat production, excessive boil off of the electrolytes and/or excessive hydrogen venting. From the absorption charging phase, the battery enters a float phase wherein the battery has reached a fully charged state (i.e., a 100% SOC) and, therefore, further power input to the battery is converted solely to the production of heat or gases (e.g., hydrogen and/or oxygen). As such, power input to the battery within the float phase must be halted in order to avoid serious damage to the batteries.

Accordingly, to avoid the increased potential for battery damage associated with the absorption and float phases of a batteries' charging cycle, the charging algorithm of the present subject matter may generally be configured to maintain the golf car's batteries 24 within the bulk charging phase. Thus, in one embodiment, the charging algorithm may be designed to monitor the SOC of the batteries 24 so as to determine when the batteries 24 reach a predetermined SOC corresponding to the transition point between the bulk charging phase and the absorption charging phase. When the charging algorithm determines that the SOC of the batteries 24 has reached or exceeded such predetermined SOC, the controller 46 may be configured to send a suitable control signal to the power generation assembly 38 or any other suitable component of the generator 34 so as to cause the power output to the batteries 24 to be halted or, at the very least, substantially reduced. For example, in the illustrated embodiment, the engine 40 of the power generation assembly 38 may be idled down in response to the control signal such that the power output to the batteries 24 is minimal or zero. Once the charging algorithm determines that the SOC of the batteries 24 has dropped below the predetermined SOC, the generator 34 may then resume power generation and/or the transmission of power to the batteries 24. By limiting charging of the batteries 24 to the bulk charging phase, the batteries 24 may be recharged up to the predetermined SOC without compromising the general operation of the vehicle and without risk of damage to the batteries 24. The batteries 24 may then be fully charged when the user of the golf car 12 has access to a stable environment to plug the golf car 12 into the main power grid (e.g., into any suitable wall outlet) and slowly bring the SOC to 100% using the golf car's peripheral charging unit.

It should be appreciated that, by permitting the generator 34 to continue running when SOC of the batteries 24 equals or exceeds the predetermined SOC, the generator 34 need not be continuously stopped/started in response to the varying SOC of the batteries 24. Accordingly, wear and tear on the generator starting mechanism may be reduced and the need for any complex time-delay algorithms upon activation/deactivation of the generator 34 can be eliminated.

It should also be appreciated that the predetermined SOC may generally vary depending on the particular type, configuration, specifications and operating conditions of the batteries 24 being utilized within the golf car 12 or other electric vehicle. As indicated above, the transition point between the bulk charging phase and the absorption charging phase for many batteries 24 generally corresponds to a SOC of about 75% to about 85%. However, various other factors, such as the magnitude of the internal temperature within the batteries 24, may have a significant effect on the particular SOC at which the batteries 24 transition from the bulk charging phase to the absorption charging phase, such as by altering the particular SOC by up to 5%. Thus, in a particular embodiment of the present subject matter, the predetermined SOC at which the generator 34 is designed to substantially limit or stop the transmission of power to the batteries 24 may be adjusted downward to compensate for any variation in the transition point due to unforeseen factors (e.g., internal battery temperature). This downward adjustment may further decrease the likelihood of any damage occurring to the batteries 24 during charging. Accordingly, in one embodiment, the predetermined SOC may be adjusted downward to a SOC ranging from about 70% to about 80%.

Referring still to FIG. 2, the disclosed generator 34 may also include a starter motor 52 configured to initiate the production of power by the generator 34. For example, in the illustrated embodiment, the starter motor 52 may comprise any suitable electric starter motor (e.g., a high torque electric motor) which is configured to initiate operation of the internal combustion engine 40 or that is otherwise configured to start the power generation assembly 38. Additionally, in a particular embodiment of the present subject matter, the starter motor 52 may be designed such that the required power input for the motor 52 is matched to the power output of the batteries 24. Specifically, the voltage requirements for the start motor 52 may be chosen so as to match the rated voltage of the batteries 24. Thus, in an embodiment in which the golf car 12 includes six batteries 24 connected in series (with each battery 24 having a voltage rating of six to eight volts), the starter motor 52 may be configured to operate on thirty-six or forty-eight volts. As such, the need for a separate battery (e.g., a separate twelve volt battery) and additional wiring may be eliminated, thereby simplifying installation and reducing the overall cost of the disclosed system. Moreover, although there may not be sufficient power remaining in the golf car's batteries 24 to operate the large, electric vehicle drive motor (not shown) of the golf car 12, there may be sufficient power available to operate the small starter motor 52. Accordingly, by matching the required voltage of the starter motor 52 to the voltage rating of the batteries 24, the starter motor 52 may be used to start the disclosed generator 34 and thereby charge the otherwise useless batteries 24.

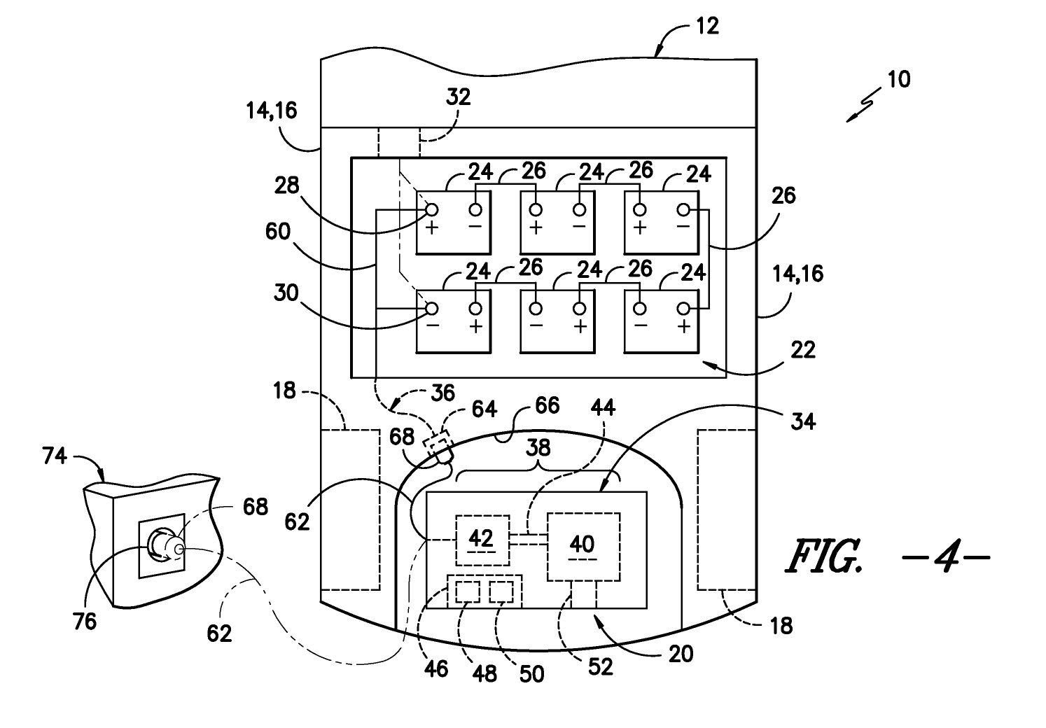

Additionally, it should be appreciated that, when the generator 34 of the present subject matter includes an electric start, the control switches (not illustrated) for the generator 34 (e.g., on/off and choke) may generally be disposed at any suitable location. For example, in one embodiment, the control switches may be mounted or otherwise disposed on the generator 34, such as on an exterior surface 90 (FIG. 4) of the generator 34. Alternatively, the control switches may be mounted or otherwise disposed at any other suitable location on the golf car 12, such as at any location which is accessible to the driver during operation of the golf car 12. For instance, the control switches may be mounted on the steering wheel of the golf car 12, on the dashboard of the golf car 12 or at any accessible location on the outer shell 16 of the body 14 (e.g., adjacent to the charging receptacle 32).

Referring still to FIG. 2, to permit the power output produced by the generator 34 to be directly transmitted to the batteries 24, the generator cable 36 of the disclosed system 10 may generally be coupled between the generator 34 and the batteries 24. It should be appreciated that the generator cable 36 may generally comprise any suitable power/electrical cable or any suitable combination/assembly of power/electrical cables known in the art that permits the electrical power of the generator 34 to be transmitted to the batteries 24. Thus, in the embodiment of FIG. 2, the generator cable 36 may simply comprise a single power cable electrically connected at a first end 56 to the generator 34 and at a second end 58 to the positive and negative posts 28, 30 of the batteries 24.

An alternative embodiment of the generator cable 36 is illustrated in FIGS. 3 and 4. As shown, the generator cable 36 may generally be configured as a cable assembly and may include two or more cable segments 60, 62. Specifically, the generator cable 36 may include a first cable segment 60 electrically coupled between the golf car's batteries 24 and a secondary charging receptacle 64. Additionally, a second cable segment 62 may be electrically coupled between the secondary charging receptacle 64 and the generator 34. As such, power may be directly transmitted from the generator 34 to the batteries 24 through the assembly of cable segments 60, 62 forming the generator cable 36.

The secondary charging receptacle 64 may generally be mounted or otherwise disposed at any location which is proximal to the location of the generator 34. Thus, in the illustrated embodiment, the secondary charging receptacle 64 may be mounted to or otherwise disposed on an exterior surface 66 of the bag well 20. Additionally, the secondary charging receptacle 64 may generally comprise any suitable charging receptacle known in the art. For example, the secondary charging receptacle 64 may be configured the same as or similar to the charging receptacle 32 of the golf car's charging system. Accordingly, it should be appreciated that the second cable segment 60 of the generator cable 36 may be configured to include a charger plug 68 adapted to be received within and make electrical contact with the secondary charging receptacle 64 so as to couple the second cable segment 62 to the first cable segment 60 and, therefore, electrically connect the generator 34 to the batteries 24. For example, as shown in FIG. 4, the charger plug 68 of the second cable segment 62 may include suitable electrical contacts 70 configured to form an electrical connection with corresponding electrical contacts 72 of the secondary charging receptacle 64. As such, the second cable segment 62 may be configured to make a solid electrical connection to the first cable segment 60 through the secondary charging receptacle 64 such that electrical power may be transmitted from the generator 34 to the batteries 24.

By configuring the generator cable 36 to include first and second cable segments 60, 62 coupled together through a secondary charging receptacle 64, various advantages may be provided to the presently disclosed system 10. For example, the generator 34 may be connected and disconnected from the batteries 24 by simply removing the charger plug 68 from the secondary charging receptacle 64. Additionally, such a cable configuration may permit the generator 34 to be used to charge the batteries of a second electric vehicle 74. For example, as shown in phantom lines in FIG. 3, the second cable segment 62 of the generator cable 36 may have any suitable length that permits the cable segment 62 to reach a second electric vehicle 74 (e.g., a second golf car) disposed generally adjacent to the vehicle 12 in which the disclosed system 10 is installed. As such, the charger plug 68 of the second cable segment 62 may be inserted into the charging receptacle 76 of the second vehicle 74 to permit the second vehicle's batteries to be charged by the generator 34.

Further, as an alternative to designing the second cable segment 62 to be capable of extending between the generator 34 and a second electric vehicle 74, the illustrated cable configuration may also permit the disclosed generator 34 to be configured as a portable device. As such, the generator 34 may be adapted to be removed from its location on the golf car 12 and moved to another location at which the second electric vehicle 74 may be charged by inserting the charger plug 68 of the second cable segment 62 into the vehicle's charging receptacle 76. Once the second electric vehicle's batteries have been sufficiently charged, the generator 34 may then be placed back into position on the golf car 12 (e.g., within the bag well 20) and re-connected to the batteries 24 through the secondary charging receptacle 64.

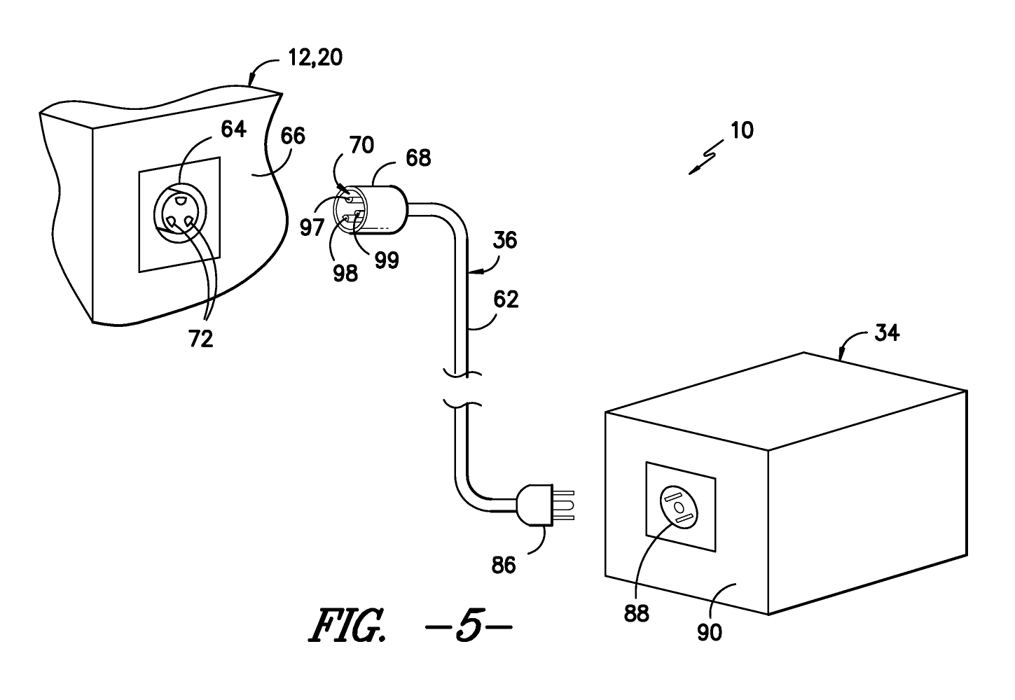

It should be appreciated by those of ordinary skill in the art that various different charger plug/receptacle configurations are utilized throughout the golf car industry by differing golf manufacturers. Similarly, LSV and ATV manufacturers often utilize differing charger plug/receptacle configurations to facilitate charging of various LSVs and ATVs. Accordingly, in a particular embodiment of the present subject matter, the disclosed system 10 may include an adapter member 78 configured to permit the charger plug 68 of the second cable segment 62 to be electrically connected to the batteries of any secondary electric vehicle 74 through the vehicle's charging receptacle. Thus, as shown in FIG. 5, in one embodiment, the adapter member 78 of the present subject matter may generally include an adapter receptacle 80 configured to receive the charger plug 68 of the second cable segment 62 such that an electrical connection can be made between the adapter member 78 and the generator cable 36. For example, the adapter receptacle 80 may generally be configured the same or similar to the secondary charging receptacle 64 in which the charger plug 68 is configured to be received. As such, the electrical contacts 70 (FIG. 4) of the charger plug 68 may be configured to form an electrical connection with the contacts 84 of the adapter receptacle 80. Additionally, the adapter member 78 may include an adapter plug 82 disposed opposite the adapter receptacle 80. The adapter plug 82 may generally be configured to be received within and make electrical contact with a charging receptacle having a configuration different than the secondary charging receptacle 64. As such, the disclosed system 10 may be utilized to re-charge the batteries of any second electric vehicle 74 having any suitable charger plug/receptacle configuration.

As indicated above, the second cable segment 62 of the generator cable 36 may generally be configured to be electrically connected between the secondary charging receptacle 64 and the generator 34. Thus, in the embodiment illustrated in FIG. 3, a portion of the second cable segment 62 may be configured to be directly wired into a component of the generator 34 (e.g., the alternator(s) 42 or the controller 46) to permit power to be transmitted from generator 34 to the batteries 24. Alternatively, as shown in FIG. 4, the second cable segment 62 may include an output plug 86, disposed opposite the charger plug 68, which is configured to be received within a corresponding receptacle 88 of the generator 34. The receptacle 88 may generally be mounted onto an exterior surface 90 of the generator 34 and wired or otherwise electrically connected to any suitable component of the generator 34 to permit the DC power output of the generator 34 to be transmitted through the receptacle 88. By using a standard receptacle 88 and output plug 86, it should be appreciated that the second cable segment 62 may easily be connected to and/or disconnected from the generator 34 to permit another cable segment having a different charger plug configuration to be inserted therein. As such, the disclosed system 10 may be configured to operate with various different charger plug/receptacle configurations by simply replacing the second cable segment 62 with a new cable segment that includes a charger plug 68 corresponding to the charging receptacle of the electric vehicle desired to be charged.

It should also be appreciated that the system 10 disclosed herein may be utilized to charge the batteries of a second electric vehicle 74 even when the generator cable 34 is not configured as a cable assembly. In particular, as shown in FIG. 2, the system 10 may include a connector cable 92 configured to be electrically coupled between the charging receptacle 32 of the golf car 12 and the charging receptacle 76 of a second electric vehicle 74. Thus, the connector cable 92 may include suitable charger plugs 94, 96 at each end which are configured to be received within and make electrical contact with the charging receptacle 32 of the golf car 12 and the charging receptacle 76 of the second electric vehicle 74, respectively. As such, the power supplied by the generator 34 to the batteries 24 of the golf car 12 may be transmitted through the connector cable 92 to the second electric vehicle 74 to permit the batteries of the second electric vehicle 74 to be charged. It should be appreciated that, in situations in which the second electric vehicle 76 includes a charging receptacle 76 that differs in configuration from the charger plug 96 of the connector cable 92, the adapter member 78 described above may be utilized to permit the connector cable 92 to be coupled to the second electric vehicle 74.

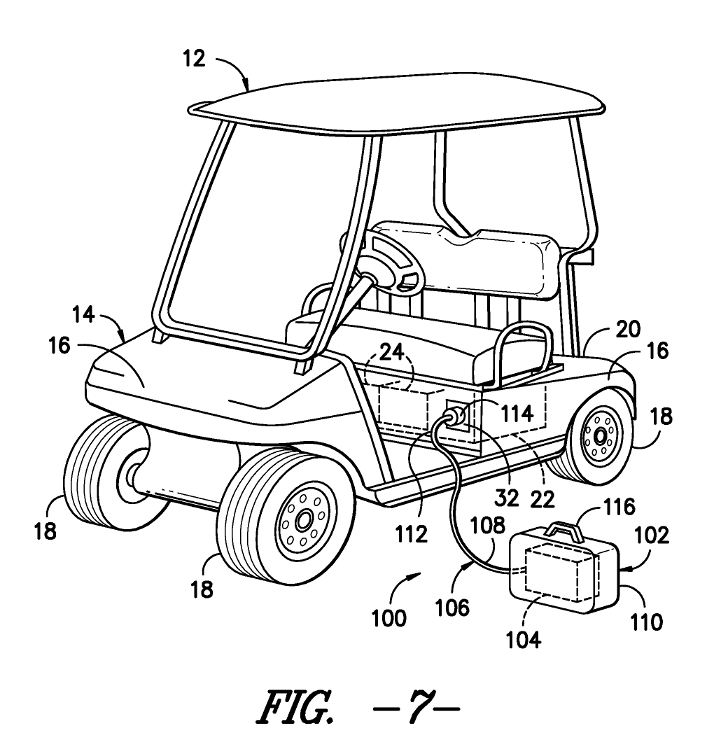

Referring now to FIG. 7, there is illustrated an embodiment of a portable system 100 for extending the driving range of an electric vehicle (e.g., a golf car 12). As shown, the system may generally include a generator 102 configured as a portable device. As such, the generator 102 may be quickly and easily transported between two or more electric vehicles, thereby permitting the generator 102 to be utilized to rescue vehicles having depleted batteries. In general, the portable generator 102 may comprise a small, relatively lightweight device configured to generate a DC power output for recharging the batteries 24 of a golf car 12 or any other electric vehicle. Thus, it should be appreciated that the portable generator 102 may include some or all of the same or similar components 104 to those described above with reference to FIGS. 2 and 4 (e.g., an internal combustion engine 40, alternator(s) 42, shaft 44, controller 46, starter motor 52 and the like) and may also utilize the same or a similar charging algorithm. Additionally, as shown, the portable generator 102 may include a generator cable 106 having a first end 108 electrically connected within the generator housing 110 and a second end 112 having a charger plug 114. Similar to that described above, the charger plug 114 may generally be configured to be received within and make electrical contact with the charging receptacle 32 of the golf car 12. As such, the portable generator 102 may be utilized to charge the golf car's batteries 24 by simply plugging the charger plug 114 into the vehicle's charging receptacle 32. Further, the portable generator 102 may also include a carrying means configured to assist in transporting the generator 102 from electric vehicle to electric vehicle. For instance, as shown, the generator 102 may include a handle 116 formed integrally with or attached to the generator housing 110.

Additionally, as indicated above, the system 10, 100 of the present subject matter may be utilized to charge a golf car's batteries 24 while the golf car 12 is stationary or while it in use. As is generally understood by those of ordinary skill in the art, many electric vehicles include a lock-out feature which prevents the vehicle from operating while its batteries are being charged. For example, the charging receptacle 32 (FIGS. 1 and 7) of a golf car 12 may often include three electrical contracts corresponding to a DC positive wire, a DC negative wire and a lock-out wire. The lock-out wire may generally be adapted to prevent the golf car 12 from being driven while the batteries 24 are charging. For example, the lock-out wire may be electrically grounded, electrically open or at a voltage so that it can be easily detected when the batteries are being charged. However, in a particular embodiment of the present subject matter, the disclosed system 10, 100 may be configured to defeat such a lock-out feature. For instance, as shown in FIG. 5, the charger plug 68 of the generator cable 36 may include electrical contacts 70 corresponding to a DC positive wire 97, a DC negative wire 98 and a lock-out wire 99. The lock-out wire 99 of the generator cable 36 may generally be configured to make electrical contact with the lock-out wire of the golf car's charging receptacle 32. Thus, by matching the electrical state of the lock-out wire 99 of the generator cable 36 to the electrical state of the lock-out wire of the golf car's charging receptacle 32 (e.g., by making the lock wire 99 grounded or open or by applying a matching voltage across the lock-out wire 99), the golf car 12 can be made to operate while its batteries 24 are being charged. As such, the need to wait for the batteries 24 to be charged prior to operating the vehicle may be eliminated. It should be appreciated that such a lock-out-defeating feature may be particularly advantageous when the disclosed system 10, 100 is being used to rescue an electric vehicle having depleted batteries.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A system for extending the driving range of an electric vehicle, the system comprising:
a generator mounted on or within the electric vehicle and configured to generate a DC power output for recharging a plurality of batteries of the electric vehicle, the generator including a controller configured to implement a charging algorithm for controlling the DC power output supplied to the plurality of batteries; and
a generator cable configured to electrically connect the generator directly to the plurality of batteries,
wherein the charging algorithm is designed to maintain the plurality of batteries below a predetermined state-of-charge corresponding to a transition point in a charging cycle of the plurality of batteries between a bulk charging phase and an absorption charging phase.

2. The system of claim 1, wherein the predetermined state-of-charge is equal to a state-of-charge of the plurality of batteries ranging from about 75% to about 85%.

3. The system of claim 1, wherein the predetermined state-of-charge is equal to a state-of-charge of the plurality of batteries ranging from about 70% to about 80%.

4. The system of claim 1, wherein the controller is configured to idle down an engine of the generator when a state-of-charge of the plurality of batteries is equal to or exceeds the predetermined state-of-charge such that minimal or no DC power output is supplied to the plurality of batteries.

5. The system of claim 1, wherein the generator further comprises a starter motor configured to require an input voltage corresponding to an output voltage of the plurality of batteries.

6. The system of claim 1, wherein the generator cable includes a first cable segment and a second cable segment, the first cable segment being coupled between the plurality of batteries and a secondary charging receptacle of the electric vehicle, the second cable segment being coupled between the secondary charging receptacle and the generator.

7. The system of claim 6, wherein the second cable segment includes an output plug configured to be received within a receptacle mounted to an exterior surface of the generator.

8. The system of claim 6, wherein the second cable segment includes a charger plug configured to be received within the secondary charging receptacle.

9. The system of claim 8, further comprising an adapter member including an adapter receptacle and an adapter plug, the adapter receptacle being configured to be connected to the charger plug of the generator cable, the adapter plug being configured to be connected to a charging receptacle of a second electric vehicle.

10. The system of claim 1, further comprising a connector cable configured to be electrically coupled between a primary charging receptacle of the electric vehicle and a charging receptacle of a second electric vehicle.

11. A system for extending the driving range of an electric vehicle, the system comprising:
a generator configured to generate a DC power output for recharging a plurality of batteries of the electric vehicle, the generator including a controller configured to implement a charging algorithm so as to maintain a state-of-charge of the plurality of batteries below a predetermined state-of-charge ranging from about 75% to about 85%, the generator further including a starter motor configured to require an input voltage corresponding to an output voltage of the plurality of batteries; and
a generator cable configured to electrically connect the generator directly to the plurality of batteries, the generator cable including a first cable segment coupled between the plurality of batteries and a secondary charging receptacle of the electric vehicle and a second cable segment coupled between the secondary charging receptacle and the generator,
wherein the predetermined state-of-charge corresponds to a transition point in a charging cycle of the plurality of batteries between a bulk charging phase and an absorption charging phase.

12. The system of claim 11, wherein the controller is configured to idle down an engine of the generator when the state-of-charge of the plurality of batteries is equal to or exceeds the predetermined state-of-charge such that minimal no DC power output is supplied to the plurality of batteries.

13. The system of claim 11, wherein the second cable segment includes an output plug configured to be received within a receptacle mounted to an exterior surface of the generator.

14. The system of claim 11, wherein the second cable segment includes a charger plug configured to be received within the secondary charging receptacle.

15. The system of claim 14, further comprising an adapter member including an adapter receptacle and an adapter plug, the adapter receptacle being configured to be connected to the charger plug of the generator cable, the adapter plug being configured to be connected to a charging receptacle of a second electric vehicle.

16. The system of claim 11, further comprising a connector cable configured to be electrically coupled between a primary charging receptacle of the electric vehicle and a charging receptacle of a second electric vehicle.

17. A portable system for extending the driving range of an electric vehicle, the system comprising:
a portable generator configured to generate a DC power output for recharging a plurality of batteries of the electric vehicle, the generator including a controller configured to implement a charging algorithm for controlling the DC power output supplied to the plurality of batteries; and
a generator cable configured to electrically connect the generator directly to the plurality of batteries, generator cable including a charger plug configured to be received within a charging receptacle of the electric vehicle,
wherein the charging algorithm is designed to maintain the plurality of batteries below a predetermined state-of-charge corresponding to a transition point in a charging cycle of the plurality of batteries between a bulk charging phase and an absorption charging phase.

18. The system of claim 17, wherein the predetermined state-of-charge is equal to a state-of-charge of the plurality of batteries ranging from about 75% to about 85%.

19. The system of claim 17, wherein a wire of the generator cable has an electrical state corresponding to an electrical state needed to defeat a lock-out feature of the electric vehicle.

20. The system of claim 17, further comprising an adapter member including an adapter receptacle and an adapter plug, the adapter receptacle being configured to be connected to the charger plug of the generator cable, the adapter plug being configured to be connected to a charging receptacle of a second electric vehicle.
